(19) United States
(12) Patent Application Publication
(10) Pub. No.: US 2007/0087139 A1
(43) Pub. Date: Apr. 19, 2007

(54) Glass fibres for reinforcing organic and/or inorganic materials, composites enclosing said fibres and used compounds

(75) Inventors: Sophie Creux, Ca Den Haag (NL); Emmanuel Lecomte, Bobigny (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN VERTROTEX FRANCE S.A., CHAMBERY FRANCE (FR)

(21) Appl. No.: 10/560,068

(22) PCT Filed: Jun. 9, 2004
(86) PCT No.: PCT/FR04/01431

§ 371 Date: Jun. 5, 2006

(30) Foreign Application Priority Data
Jun. 11, 2003 (FR) 03/06981

(51) Int. Cl. B41M 5/40

(52) U.S. Cl. 428/32.71

(57) ABSTRACT

The invention relates to glass reinforcing yams, the composition of which comprises the following constituents, within the limits defined below, expressed in percentages by weight:

| | |
|---|---|
| SiO₂ | 50-65% |
| Al₂O₃ | 12-20% |
| CaO | 13-16% |
| MgO | 6-12% |
| B₂O₃ | 0-3% |
| TiO₂ | 0-3% |
| Na₂O + K₂O | <2% |
| F₂ | 0-1% |
| Fe₂O₃ | <1. |

These yarns are made of a glass offering an excellent compromise between its mechanical properties represented by the specific Young's modulus and its melting and fiberizing conditions.

The present invention relates to glass “reinforcing” yams (or “fibers”), that is to say yarns suitable for reinforcing organic and/or inorganic materials and able to be used as textile yams, it being possible for these yarns to be obtained by the process consisting in mechanically drawing the streams of molten glass flowing out of orifices located in the base of a bushing, which is generally heated by resistance heating.

The object of the present invention is more precisely to obtain glass yarns having a high specific Young's modulus and having a particularly advantageous quaternary composition of the SiO₂—Al₂O₃—CaO—MgO type.

The field of glass reinforcing yams is a very particular field of the glass industry. These yarns are produced from specific glass compositions, the glass used having to be able to be drawn in the form of filaments a few microns in diameter using the process indicated above and having to allow the formation of continuous yarns capable of fulfilling a reinforcing role.

In certain applications, especially in aeronautics, the aim is to obtain large components suitable for operating under dynamic conditions and consequently capable of withstanding high mechanical stresses. These components are usually based on organic and/or inorganic materials and a reinforcement, for example in the form of glass yarns, which in general occupies more than 50% of the volume.

The improvement in the mechanical properties and in the yield of such components is achieved by improving the mechanical performance of the reinforcement, especially the Young's modulus for a constant, or even lower, reinforcement density ρ, which amounts to increasing the specific Young's modulus (E/ρ).

The properties of the reinforcement, in the case of glass reinforcing yams, are mainly governed by the composition of the glass of which they are made. The most common glass yams for reinforcing organic and/or inorganic materials are made of E-glass and R-glass.

E-glass yarns are widely used to form reinforcements, either as such, or in the form of fabrics. The conditions under which the E-glass can be fiberized are highly advantageous: the working temperature, corresponding to the temperature at which the glass has a viscosity close to 1000 poise, is relatively low, around 1200° C., the liquidus temperature is about 120° C. below the working temperature, and its devitrification rate is low.

The E-glass composition defined in the ASTM D 578-98 standard for applications in the electronics and aeronautical fields is the following (n percentages by weight): 52 to 56% SiO₂; 12 to 16% Al₂O₃; 16 to 25% CaO; 5 to 10% B₂O₃; 0 to 5% MgO; 0 to 2% Na₂O+K₂O; 0 to 0.8% TiO₂; 0.05 to 0.4% Fe₂O₃; and 0 to 1% F₂.

However, E-glass has a specific Young's modulus of around 33 MPa.kg⁻¹.m³, insufficient for the intended application.

Other E-glass reinforcing yams, optionally containing no boron, are described in the ASTM D 578-98 standard. These yams have the following composition (in percentage by weight): 52 to 62% SiO₂; 12 to 16% Al₂O₃; 16 to 25% CaO; 0 to 10% B₂O₃; 0 to 5% MgO; 0 to 2% Na₂O+K₂O; 0 to 1.5% TiO₂; 0.05 to 0.8% Fe₂O₃; and 0 to 1% F₂.

The conditions for fiberizing boron-free E-glass are less favorable than those for E-glass containing boron, but they do remain, however, economically acceptable. The specific Young's modulus remains at a performance level equivalent to that of E-glass.

An E-glass containing no boron and no fluorine, which has an improved tensile strength, is also known from U.S. Pat. No. 4,199,364. This glass contains especially lithium oxide.

R-glass is known for its high mechanical properties and has a specific Young's modulus of about 35.9 MPa.kg⁻¹.m³. However, the melting and fiberizing conditions are more restricted than for the E-type glasses mentioned, and therefore its final cost is higher.

The composition of R-glass is given in FR-A-1 435 073. It is the following (in percentages by weight): 50 to 65% SiO₂; 20 to 30% Al₂O₃; 2 to 10% CaO; 5 to 20% MgO; 15 to 25% CaO+MgO; SiO₂/Al₂O₃=2 to 2.8; MgO/SiO₂<0.3.

Other attempts at increasing the mechanical strength of glass yarns have been made, but generally to the detriment of their fiberizability, the processing then becoming more difficult or requiring existing fiberizing plants to be modified.

There therefore exists a need for glass reinforcing yams having a cost as close as possible to that of E-glass and exhibiting mechanical properties at a performance level comparable to that of R-glass.

One object of the present invention is to provide continuous glass reinforcing yams whose mechanical properties are of the same order of magnitude as those of R-glass, in particular regarding the specific Young's modulus, while still having satisfactory melting and fiberizing properties in order to obtain reinforcing yarns economically.

Another object of the invention is to provide inexpensive glass yarns containing no lithium oxide.

These objects are achieved by means of glass yarns the composition of which essentially comprises the following constituents, within the limits defined below, expressed in percentages by weight:

| | |
|---|---|
| SiO₂ | 50-65% |
| Al₂O₃ | 12-20% |
| CaO | 13-16% |
| MgO | 6-12% |
| B₂O₃ | 0-3% |
| TiO₂ | 0-3% |
| Na₂O + K₂O | <2% |
| F₂ | 0-1% |
| Fe₂O₃ | <1%. |

Silica (SiO₂) is one of the oxides that forms the network of the glasses according to the invention and plays an essential role in their stability. Within the context of the invention, when the silica content is less than 50%, the viscosity of the glass becomes too low and the risk of devitrification during fiberizing is increased. Above 65%, the glass becomes very viscous and difficult to melt. Preferably, the silica content is between 56 and 61%.

Alumina (Al₂O₃) also constitutes a network former for the glasses according to the invention and plays an essential role with regard to the modulus, combined with silica. Within the context of the limits defined according to the invention, decreasing the amount of this oxide to below 12% results in an increase in the liquidus temperature, whereas excessively increasing the amount of this oxide to above 20% results in the risk of devitrification and an increase in the viscosity. Preferably, the alumina content of the selected compositions is between 14 and 18%. Advantageously, the sum of the silica and alumina contents is greater than 70%, which makes it possible to obtain useful values of the specific Young's modulus.

Lime (CaO) is used to adjust the viscosity and to control the devitrification of the glasses. The CaO content is preferably between 13 and 16%.

Magnesia (MgO), just like CaO, acts as a viscosity reducer and also has a beneficial effect on the specific Young's modulus. The MgO content is between 6 and 12%, preferably between 8 and 10%. The CaO/MgO weight ratio is preferably greater than or equal to 1.40 and advantageously is less than or equal to 1.8.

Also preferably, the sum of the Al₂O₃ and MgO contents is greater than or equal to 24%, which makes it possible to obtain very satisfactory specific Young's modulus values and good fiberizing conditions.

Boron oxide (B₂O₃) acts as a viscosity reducer. Its content in the glass composition according to the invention is limited to 3%, preferably 2%, in order to avoid volatilization and pollutant-emission problems.

Titanium oxide acts as a viscosity reducer and helps to increase the specific Young's modulus. It may be present as an impurity (its content in the composition is then from 0 to 0.6%) or it may be intentionally added. In the latter case, it is necessary to use nonstandard batch materials, which increases the cost of the composition. Within the context of the present invention, the deliberate addition of TiO₂ is advantageous only with a content of less than 3%, preferably less than 2%.

Na₂O and K₂O may be introduced into the composition according to the invention so as to help to limit devitrification and possibly to reduce the viscosity of the glass. The Na₂O and K₂O content must, however, remain less than 2% in order to avoid a prejudicial reduction in the hydrolytic resistance of the glass. Preferably, the composition contains less than 0.8% of these two oxides.

Fluorine (F₂) may be present in the composition in order to help the melting of the glass and the fiberizing. However, its content is limited to 1%, since above this limit there may be a risk of pollutant emissions and corrosion of the furnace refractories.

Iron oxides (expressed in the form of Fe₂O₃) are generally present as impurities in the composition according to the invention. The Fe₂O₃ content must remain less than 1%, preferably less than 0.8%, in order not to unacceptably impair the color of the yams and the operation of the fiberizing plant, in particular the heat transfer in the furnace.

The glass yams according to the invention contain no lithium oxide. Apart from its high cost, this oxide has a negative impact on the hydrolytic resistance of the glass.

Preferably, the glass yarns have a composition essentially comprising the following constituents, within the limits defined below, expressed in percentages by weight:

| | |
|---|---|
| SiO₂ | 56-61% |
| Al₂O₃ | 14-18% |
| CaO | 13-16% |
| MgO | 8-10% |
| B₂O₃ | 0-2% |
| TiO₂ | 0-2% |
| Na₂O + K₂O | <0.8% |
| F₂ | 0-1% |
| Fe₂O₃ | <0.8%. |

It is particularly advantageous for the compositions to have an Al₂O₃/(Al₂O₃+CaO+MgO) weight ratio that varies from 0.4 to 0.44 and is preferably less than 0.42, thereby making it possible to obtain glasses having a liquidus temperature less than or equal to 1250° C.

The glass yams according to the invention are obtained from the glasses with the composition described above using the following process: a multiplicity of molten glass streams, flowing out of a multiplicity of orifices located at the base of one or more bushings, are drawn into the form of one or more bundles of continuous yams and then the filaments are combined into one or more yams that are collected on a moving support. This may be a rotating support when the yams are collected in the form of packages, or a support that moves translationally when the yarns are made into chopped strands by a device that also serves to draw them, or when the strands are sprayed by a device serving to draw them so as to form a mat.

The yarns obtained, optionally after other conversion operations, may thus be in various forms: continuous yarns, chopped strands, braids, tapes or mats, these yarns being composed of filaments whose diameter may range from 5 to 30 microns approximately.

The molten glass feeding the bushings is obtained from pure batch materials or, more usually, natural batch materials (i.e. those possibly containing trace impurities), these batch materials being mixed in appropriate amounts, before being melted. The temperature of the molten glass is conventionally adjusted so as to allow fiberizing and to avoid devitrification problems. Before they are combined in the form of yams, the filaments are generally coated with a sizing composition aimed at protecting them from abrasion and making it easier for them to be subsequently incorporated into the materials to be reinforced.

The composites obtained from the yams according to the invention comprise at least one organic material and/or at least one inorganic material and glass yarns, at least some of the yams being the yarns according to the invention.

The examples that follow allow the invention to be illustrated, without however limiting it.

Glass yams composed of 17 μm diameter glass filaments were obtained by drawing molten glass having the composition given in Table 1, expressed in percentages by weight.

The temperature at which the viscosity of the glass is equal to 10³ poise (decipascal second) is denoted by T_{log η=3}.

The liquidus temperature of the glass is denoted by T_{liquidus}, this corresponding to the temperature at which the most refractory phase, which may devitrify in the glass, has a zero rate of growth and thus corresponds to the melting point of this devitrified phase.

The table gives the values of the specific Young's modulus, which corresponds to the ratio of Young's modulus (measured using the ASTM C 1259-01 standard) to the density of the glass specimen used for the measurement.

Measurements on E-glass and R-glass are given as comparative examples.

This shows the examples according to the invention exhibit an excellent compromise between the melting and fiberizing properties and the mechanical properties. These fiberizing properties are particularly advantageous, especially with a liquid temperature at least equal to 1280° C., which is lower than that of R-glass. The fiberizing range is positive, especially with a difference between T_{log η=3} and T_{liquidus} of about 10 to 50° C.

The specific Young's modulus of the compositions according to the invention is of the same order of magnitude as that of R-glass and substantially higher than that of E-glass.

Thus, with the glasses according to the invention, it is remarkable that mechanical properties of the same level as for R-glass are achieved, while still substantially lowering the fiberizing temperature so as to approach the value obtained for E-glass.

The glass yarns according to the invention are less expensive than the R-glass yarns that they can advantageously replace in certain applications, especially aeronautical applications, or for the reinforcement of helicopter blades or for optical cables.

TABLE 1

| | Ex. 1 | Ex. 2 | Ex. 3 | Ex. 4 | Ex. 5 | Ex. 6 | Ex. 7 | E-glass | R-glass |
|---|---|---|---|---|---|---|---|---|---|
| SiO₂ | 59.5 | 58.8 | 58.0 | 57.7 | 57.5 | 58.5 | 59.5 | 54.4 | 60.0 |
| Al₂O₃ | 15.9 | 17.0 | 17.9 | 16.0 | 16.0 | 16.9 | 16.2 | 14.5 | 25.0 |
| CaO | 14.8 | 14.6 | 14.4 | 14.8 | 14.9 | 13.3 | 13.8 | 21.2 | 9.0 |
| MgO | 8.8 | 8.6 | 8.5 | 8.7 | 8.8 | 10.0 | 9.5 | 0.3 | 6.0 |
| B₂O₃ | | | | 1.8 | | | | 7.3 | |
| TiO₂ | 0.1 | 0.1 | 0.2 | 0.1 | 2.0 | 0.1 | 0.1 | | |
| Na₂O | 0.1 | 0.1 | 0.1 | 0.1 | 0.1 | 0.1 | 0.1 | 0.6 | |
| K₂O | 0.5 | 0.5 | 0.6 | 0.5 | 0.5 | 0.5 | 0.5 | | |
| T_{log η=3} (° C.) | 1281 | 1285 | 1289 | 1254 | 1271 | 1292 | 1298 | 1203 | 1410 |
| T_{liquidus} (° C.) | 1230 | 1260 | 1280 | 1220 | 1240 | 1250 | 1210 | 1080 | 1330 |
| Specific Young's | 35.2 | 35.4 | 35.4 | 35.4 | 35.6 | 35.8 | 35.6 | 33.0 | 35.9 |
| modulus (MPa · kg⁻¹ · m³) | | | | | | | | | |

1. A glass reinforcing yarn, the composition of which essentially comprises the following constituents, within the limits defined below, expressed in percentages by weight:

| | |
|---|---|
| SiO₂ | 50-65% |
| Al₂O₃ | 12-20% |
| CaO | 13-16% |
| MgO | 6-12% |
| B₂O₃ | 0-3% |
| TiO₂ | 0-3% |
| Na₂O + K₂O | <2% |
| F₂ | 0-1% |
| Fe₂O₃ | <1%. |

2. The glass yam as claimed in claim 1, characterized in that the composition has an MgO+Al₂O₃ content of greater than 24%.

3. The glass yarn as claimed in either of claims 1 and 2, characterized in that the composition has an SiO₂+Al₂O₃ content of greater than or equal to 70%.

4. The glass yarn as claimed in one of claims 1 to 3, characterized in that the composition has an Al₂O₃/(Al₂O₃+CaO+MgO) weight ratio that varies from 0.40 to 0.44 and is preferably less than 0.42.

5. The glass yarn as claimed in one of claims 1 to 4, characterized in that the composition has a CaO/MgO weight ratio of greater than or equal to 1.40 and preferably less than or equal to 1.8.

6. The glass yarn as claimed in one of claims 1 to 5, characterized in that the composition essentially comprises the following constituents:

| | |
|---|---|
| SiO₂ | 56-61% |
| Al₂O₃ | 14-18% |
| CaO | 13-16% |
| MgO | 8-10% |
| B₂O₃ | 0-2% |
| TiO₂ | 0-2% |
| Na₂O + K₂O | <0.8% |
| F₂ | 0-1%. |
| Fe₂O₃ | <0.8%. |

7. A composite consisting of glass yarns and one or more organic and/or inorganic materials, characterized in that it comprises glass yams as defined by one of claims 1 to 6.

8. A glass composition suitable for producing glass reinforcing yarns, which essentially comprises the following constituents, within the limits defined below, expressed in percentages by weight:

| | |
|---|---|
| SiO₂ | 50-65% |
| Al₂O₃ | 12-20% |
| CaO | 13-16% |
| MgO | 6-12% |
| B₂O₃ | 0-3% |
| TiO₂ | 0-3% |
| Na₂O + K₂O | <2% |
| F₂ | 0-1% |
| Fe₂O₃ | <1%. |
